(19) United States
(12) Patent Application Publication
(10) Pub. No.: US 2009/0134849 A1
(43) Pub. Date: May 28, 2009

(54) Self-Regulated Permanent Magnet Generator

(76) Inventor: Carlos Gottfried, Mexico (MX)

Correspondence Address: ARTHUR M DULA;LAW OFFICE OF ARTHUR M DULA, 3106 BEAUCHAMP STREET, HOUSTON, TX, 77009, US

(21) Appl. No.: 11/990,322

(22) PCT Filed: Aug. 14, 2006
(86) PCT No.: PCT/US2006/031750

§ 371 Date: Feb. 11, 2008

Related U.S. Application Data
(60) Provisional application No. 60/707,784, filed on Aug. 12, 2005.

(51) Int. Cl. H02P 9/32; H02K 21/14

(52) U.S. Cl. 322/57; 310/179

(57) ABSTRACT

An alternating current generator comprising: permanent magnet means for generating a rotating magnetic field; armature means for containing at least two field windings adjacent to said permanent magnetic field and within said rotating magnetic field; a primary winding said armature means, said primary winding being of connection to a load; and a secondary winding offset from said primary winding on said armature, said secondary winding being connected to a capacitive load.

### BACKGROUND

### Description of the Related Art

The discovery of electromagnetic induction was announced by Faraday in a paper read before the Royal Society on Nov. 24, 1831. Inventors immediately began the development of magneto-electric machines of various designs. Therefore, in 1832, it was known that passage of an electric current through a conductor set up a magnetic field. The concept of the lines of force had been established, and it was known that rotation of a coil of wire within the field of a permanent magnet would cause a voltage to be generated in the wire.

It is familiar knowledge that electric generators comprise two parts; a field system, in which the early machines consisted of simple or compound permanent magnets; and a system of coils, or windings, in which the generation of electricity takes place. Relative movement of the two systems is essential; but, whether the magnets or the coils move is immaterial, and in fact, both types of construction have been used.

After Faraday's laboratory demonstrations, the first magneto electric machine exhibited to the public was shown by Hippolyte Pixii in Paris in 1832. In this machine, the field magnet revolved with respect to the coils. It was hand driven and little more than a working model; yet, it was the first practical generator constructed on Faraday's principle.

The first manufacture of electric generators on a commercial scale was by E. M. Clarke. In the 1830's, he was in business in London as a maker of scientific instruments. Clarke's designs differed from its predecessors in that the coils were caused to rotate in a plain parallel with the sides of the magnet. Clarke seems to have been the first to experiment with different types of windings, and soon found that he could vary the output to suit the requirements of the user.

On Apr. 11, 1855, British patent no. 806 was granted to Soren Hjorth of Denmaik for “an improved magneto-electric battery”. The machine described is an electric generator whose main excitation derives from electromagnets. Hjorth recognized the advantages obtainable from an electromagnet field system, i.e., that the field strength of the magnetic field may be varied. The drawings accompanying his patent indicated a machine in which a rotating disk carrying a series of coils is made to revolve between two banks of electromagnets, to which are added permanent magnets for supplying the initial excitation.

In December of 1866, E. W. Von Siemens submitted a paper to the Berlin Academy of Sciences describing the conversion of mechanical into electrical energy without the use of permanent magnets. On Feb. 14, 1867, his brother Charles Siemens communicated the papers contents to the Royal Society in London and exhibited a hand driven model generator demonstrating the self excitation principle.

Today, it is generally conceited that Zenobe Gramme constructed the first dynamo capable of producing a truly continuous current. By 1873, the Gramme Company had supplied a machine for public trial at the clock tower at Westminster, England. By 1874, Gramme's dynamos were used in at least two capital ships of the French navy and in some vessels of the Russian navy.

Therefore, the entire history of the art of electric generation is a progress from the use of permanent magnet field systems to the use of electromagnetic self exciting dynamos. The reason for this evolution is that a synchronous, i.e., constant rotational speed, ac generator that is excited by the field of a permanent magnet produces a voltage that is inversely proportional to the lad placed on it. As the load increases, output voltage drops. This defect of permanent magnet ac synchronous generators has heretofore kept them from being used commercially. All conventional generators taught by the prior art, i.e., those using electromagnets for field excitation, must have those rotating windings electrically connected by slip-rings or commutators. These slip-rings or commutators and their associated brushes, are subject to failure due to wear. Such rings and commutators must be replaced or maintained. They present a problem which the prior art has not overcome, prior to the present invention.

A.C. power is produced by generators which operate at fixed rotational speeds. These generators move a winding through a magnetic field inducing a flow of current according to Faraday's Law. When the magnetic field inducing the flow of electric current is constant and the velocity of the conductor through the field is also constant, then the voltage produced by the generator will be a direct function of the load placed on the generator. As the load increased, the output voltage will decrease in accordance with the well known electrical laws for predicting the behavior of ac circuits.

If the magnetic field in an alternating current generator which operates at a constant is generated by the movement of a permanent magnet, then the magnetic field strength of the main field is constant; and thus, the voltage output of the generator will be inversely related to the load placed across the generators output. This inverse relationship of voltage output to load has heretofore prevented permanent magnets from being used as the main field in synchronous alternating current generators. Permanent magnet generators are simple and reliable because they do not require electrical connections to the rotating portion of the generator carrying the permanent magnets, which provide the main field.

The present inventor does not know of any prior art that teaches a permanent magnet alternating current generator which operates at a constant speed under varying electric loads that avoids this old problem of having the generator's voltage drop as load is increased.

Most electrical loads comprise electronic equipment that requires voltage regulations for proper operation. There is an inability of permanent magnet alternating current generators to provide regulated voltage output because of their inherently fixed magnetic field. The prior art teaches the use of voltage regulated wound field generators wherein the portion of the generator used to generate the magnetic field is an electromagnet whose field strength may be varied by means of an electronic or magnetic feedback circuit according to the load requirements placed on the main generator.

These wound field generators rely on various means of voltage regulation. For example, an alternating current generator may provide voltage regulation by varying the field strength of the electromagnetic winding which generates the main field of the generator to compensate for the armature reaction caused by loading across the output of the generator. This can be accomplished through a feedback circuit using an external electronic or magnetic voltage regulator. These voltage control means are well known to anyone skilled in the art of electrical machine design. Alternatively, the prior art also teaches the use of separate excitation windings located approximately 90 degrees from the principle winding. These excitation windings react to the main load by an increase in voltage, which increases the main magnetic field and thereby compensates for the reactance caused by the increased load across the output of the generator. It is also well known in the prior art to pass the main windings through an external brushless generator field, which has the effect of increasing the main field strength to compensate for increased load.

### SUMMARY OF THE INVENTION

The present invention is a permanent magnet generator wherein the main rotating magnetic field is provided by a permanent magnet. The load is connected to a principle winding wound around an armature and said armature is further provided with the secondary winding offset from the primary winding by 90 degrees and connected to a capacitive load. The value of the capacitive load is selected so the reactance of the secondary winding will cancel the reactance of the primary winding when full load is applied across the primary winding.

### BRIEF DESCRIPTION OF THE DRAWING

FIG. 1, which is a schematic sectional view of a generator constructed according to the preferred embodiment of the present invention.

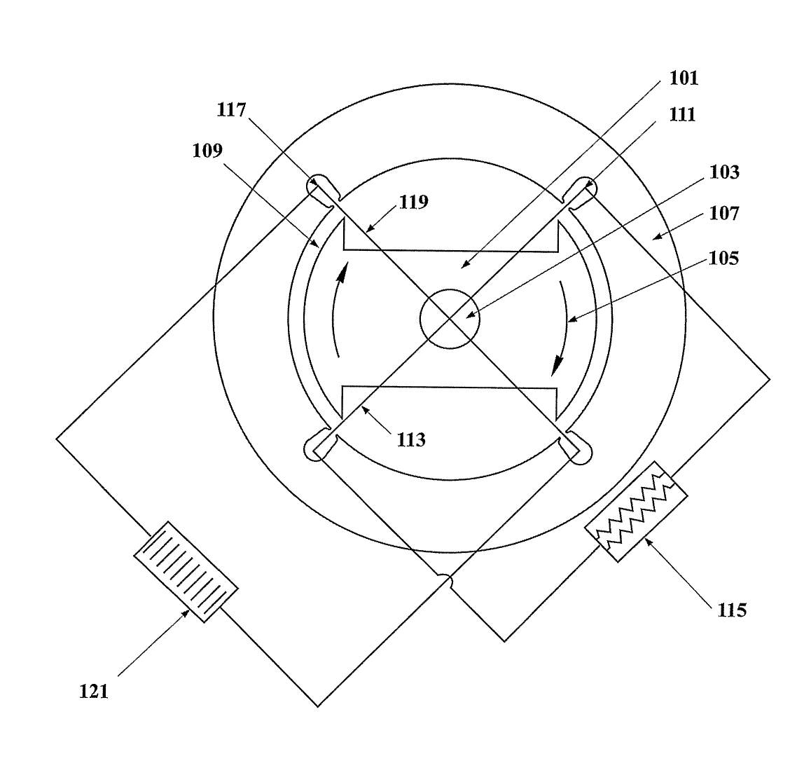

### CONCEPT OF THE PREFERRED EMBODIMENT

Permanent magnet 101 rotates on shaft 103 in the direction shown by arrow 105. An annular armature 107 cylindrically surrounds permanent magnet 101. Armature 107 and permanent magnet 101 define annulus 109.

Armature 107 is fitted with primary winding slot 111 which contains primary winding 113. Primary winding 113 is connected in parallel with a load 115, which is an electric load.

Electric load 115 may be any apparatus whose proper operation requires a controlled voltage.

Armature 107 is further equipped with secondary winding channel 117 offset 90 degrees from the primary winding which receives a secondary winding 119. Secondary winding 119 is connected in parallel with a capacitive load 121.

The value of capacitive load 121 is selected so that the reactance generated by capacitive load 121 and secondary winding 119 will be directly proportional to the reactance generated by the circuit formed by resistive load 115 and primary winding 113.

The primary and secondary windings of the present invention may be either single or multi phase windings. If the secondary winding is a multi phase winding, then the capacitive load 121 will be a multi phase capacitive load.

A permanent magnetic field, not shown, generated by permanent magnet 101; rotates around armature 107 inducing a voltage in primary winding 113 and secondary winding 119. Capacitive load 121 is of sufficient capacity to provide the necessary armative reactance to equal the armature reactance from load 115, at full load.

Functionally, under no load, in the present invention, the vector sum of the excitation produced by rotating permanent magnet 101 and secondary electrical winding 119 connected to capacitive load 121 will produce the generator's nominal output voltage across primary winding 113.

When load 115 is connected across primary winding 113, the reactance of the primary winding will be canceled by the reactance of secondary winding 119 and capacitive load 121. Secondary winding 119 is approximately 90 degrees from primary winding 113, thus the reactance of winding 119 will be directly proportional to the load on winding 113.

As a result, the voltage output of the permanent magnet ac generator taught by the present invention is relatively constant, from no load to full load. Thus the present invention thereby achieves voltage regulation of a permanent magnet synchronous ac constant speed generator without the use of an external regulator connected to any wound field.

The inventor believes that the present invention is a general advance in the art of ac constant voltage generators. Its novel result, in the Inventor's opinion, is its ability to provide a voltage regulated output from a constant speed permanent magnet generator without using a wound field. Thus, although the above schematic example shows the general case of the preferred embodiment of the present invention, the present invention should not be limited to this specific embodiment, but should only be limited by the scope of the appended claims and their equivalents.

1. An alternating current generator comprising:
a. permanent magnet means for generating a rotating magnetic field;
b. armature means for containing at least two field windings adjacent to said permanent magnetic field and within said rotating magnetic field;
c. a primary winding said armature means, said primary winding being of connection to a load; and
d. a secondary winding offset from said primary winding on said armature, said secondary winding being connected to a capacitive load.

2. A generator as in claim 1 wherein the armature reactance of said capacitive load is equal to the armature reactance of the primary winding when full load is applied across the primary winding.

3. A generator as in claim 1 wherein the armature reactance of said capacitive load is equal to the armature reactance of the primary winding when full load is applied across the primary winding and said offset is approximately 90 degrees.

4. A generator as in claim 1 wherein the armature reactance of said capacitive load is equal to the armature reactance of the primary winding when full load is applied across the primary winding, said offset is approximately 90 degrees, and the rotation of said magnetic field is at a constant angular velocity.
